(19) United States
(12) Patent Application Publication
(10) Pub. No.: US 2002/0159460 A1
(43) Pub. Date: Oct. 31, 2002

(54) Flow control system to reduce memory buffer requirements and to establish priority servicing between networks

(76) Inventors: Michael W. Carrafiello, Hudson, NH (US); John C. Harames, West Haven, UT (US); Roger W. McGrath, Winchendon, MA (US)

Correspondence Address: Chris A. Caseiro, Enterasys Networks, Inc., 50 Minuteman Road, Andover, MA, 01810, US

(21) Appl. No.: 10/132,647

(22) Filed: Apr. 25, 2002

Related U.S. Application Data
(60) Provisional application No. 60/287,502, filed on Apr. 30, 2001.

(51) Int. Cl. H04L 12/56

(52) U.S. Cl. 370/392; 370/412

(57) ABSTRACT

The invention is a system and method to allow precise control of the transmit packet rate between two different networks and to optionally introduce a priority servicing scheme across several related output ports of a switch engine. The invention employs flow control circuitry to regulate data packet flow across a local interface within a single device by asserting back-pressure. Specifically, flow control is used to prevent a switch port from transmitting a data packet until a subsequent processing stage is ready to accept a packet via that port. The downstream node only permits transmission of packets from the switch when its buffer is available. An interface block effectively multiplexes together multiple switch ports by maintaining constant back-pressure on all of the ports and then releasing the back-pressure, one port at a time, to see if a port has a packet to transmit. This use of back-pressure to control the flow of data packets also allows a priority servicing scheme to be implemented by controlling the sequence of releasing back-pressure to the ports and also the number of packets allowed out of a port when it is allowed to transmit.

### CROSS REFERENCE TO RELATED APPLICATION

This application claims the priority benefit of provisional U.S. application Ser. No. 60/287,502, filed Apr. 30, 2001, of the same title, by the same inventors and assigned to a common owner. The contents of that priority application are incorporated herein by reference.

### BACKGROUND OF THE INVENTION

1. Field of the Invention

The present invention relates to communications network switching and, in particular, to reduction of memory buffering requirements when interfacing between two networks.

2. Description of the Prior Art

Computing systems are useful tools for the exchange of information among individuals. The information may include, but is not limited to, data, voice, graphics, and video. The exchange is established through interconnections linking the computing systems together in a way that permits the transfer of electronic signals that represent the information. The interconnections may be either wired or wireless. Wired connections include metal and optical fiber elements. Wireless connections include, but are not limited to, infrared and radio wave transmissions.

A plurality of interconnected computing systems having some sort of commonality represents a network. For example, individuals associated with a college campus may each have a computing device. In addition, there may be shared printers and remotely located application servers sprinkled throughout the campus. There is commonality among the individuals in that they all are associated with the college in some way. The same can be said for individuals and their computing arrangements in other environments including, for example, healthcare facilities, manufacturing sites and Internet access users. In most cases, it is desirable to permit communication or signal exchange among the various computing systems of the common group in some selectable way. The interconnection of those computing systems, as well as the devices that regulate and facilitate the exchange among the systems, represent a network. Further, networks may be interconnected together to establish internetworks.

The process by which the various computing systems of a network or internetwork communicate is generally regulated by agreed-upon signal exchange standards and protocols embodied in network interface cards or circuitry. Such standards and protocols were borne out of the need and desire to provide interoperability among the array of computing systems available from a plurality of suppliers. Two organizations that have been substantially responsible for signal exchange standardization are the Institute of Electrical and Electronic Engineers (IEEE) and the Internet Engineering Task Force (IETF). In particular, the IEEE standards for internetwork operability have been established, or are in the process of being established, under the purview of the 802 committee on Local Area Networks (LANs) and Metropolitan Area Networks (MANs).

The primary connectivity standard employed in the majority of wired LANs is IEEE802.3 Ethernet. In addition to establishing the rules for signal frame sizes and transfer rates, the Ethernet standard may be divided into two general connectivity types: full duplex and half-duplex. In a full duplex arrangement, two connected devices may transmit and receive signals simultaneously in that independent transfer lines define the connection. On the other hand, a half duplex arrangement defines one-way exchanges in which a transmission in one direction must be completed before a transmission in the opposing direction is permitted. The Ethernet standard also establishes the process by which a plurality of devices connected via a single physical connection share that connection to effect signal exchange with minimal signal collisions. In particular, the devices must be configured so as to sense whether that shared connector is in use. If it is in use, the device must wait until it senses no present use and then transmits its signals in a specified period of time, dependent upon the particular Ethernet rate of the LAN. Full duplex exchange is preferred because collisions are not an issue. However, half duplex connectivity remains a significant portion of existing networks.

While the IETF and the IEEE have been substantially effective in standardizing the operation and configuration of networks, they have not addressed all matters of real or potential importance in networks and internetworks. In particular regard to the present invention, there currently exists no standard, nor apparently any plans for a standard, that enables the interfacing of network devices that operate at different transmission rates, different connectivity formats, and the like. Nevertheless, it is common for disparate networks to be connected. When they are, problems include signal loss and signal slowing. Both are unacceptable conditions as the desire for faster and more comprehensive signal exchange increases. For that reason, it is often necessary for equipment vendors to supply, and end users to have, interface devices that enable transition between devices that otherwise cannot communicate with one another. An example of such an interface device is an access point that links an IEEE802.3 wired Ethernet system with an IEEE802.11 wireless system.

The traditional way of dealing with interfacing dissimilar (different speed networks) is to match or exceed the buffering of the Ethernet network, as shown in FIG. 1, by an amount determined to be sufficient to prevent data loss due to inefficiencies of the slower network. In this model, as any Ethernet port transmits data, the receiving network accepts the data at the transmitted Ethernet rate and stores it in buffers until the data can be retransmitted at the slower rate. As a result, buffers 10 are required for each port that may transmit. The non-Ethernet network interface 20 requires equivalent buffering to the Ethernet device 30 (such as an Ethernet switch engine) to ensure adequate data throughput. In the case where the non-Ethernet network interface 20 cannot process data as fast as the Ethernet device 30, buffering in the non-Ethernet network interface 20 must be larger than that used on the Ethernet device 30 side. It had been the practice to add as much memory as needed to ensure desired performance. That approach can be costly and complex and can use up valuable device space.

Matching buffering capacity is generally done in one of two ways, discrete memory components and/or memory arrays implemented in logic cores, e.g., Field Programmable Gate Arrays (FPGAs) or Application Specific Integrated Circuits (ASICs); both methods are costly. Of the two, adding discrete memory chips is more common. As indicated, adding discrete memory chips increases component count on the board; translating directly into higher cost and lower reliability (higher chance of component failure). Whereas, implementing memory in logic core devices is gate intensive. Memory arrays require high gate counts to implement. Chewing up logic gates limits functionality within the device that could otherwise be used for enhanced features or improved functionality. In addition, FPGA and ASIC vendors charge a premium for high gate count devices. This impact is why adding discrete memory components is usually pursued over implementing memory in logic core devices.

Therefore, what is needed is a system and method to ensure compatible performance between network devices, including at least one having multiple data exchange ports, operating at different rates while minimizing the need for extra memory and/or complex memory schemes. An additional desired feature of such a system and method is to provide priority servicing for the exchange ports.

### SUMMARY OF THE INVENTION

It is an object of the present invention to provide a system and method to ensure compatible performance between network devices, including at least one having multiple data exchange ports, operating at different rates while minimizing the need for extra memory and/or complex memory schemes. It is also an object of the present invention to provide such a system and method with priority servicing for the exchange ports.

These and other objects are achieved in the present invention, which includes an interface block with flow control circuitry that manages the transfer of data from a multiport network device. The interface block includes memory sufficient to enable transfer of the data forward at a rate that is compatible with the downstream device, whether that device is slower or faster than the multiport device. Further, the transfer is achieved without dropping data packets as a result of rate differentials.

This invention uses the hardware flow control feature, common in widely available Ethernet switch engines, to reduce memory buffer requirements. The memory buffers are located in a hardware interface between a common Ethernet switch engine and a dissimilar network interface, such as an 802.11 wireless LAN. Memory buffering can be reduced to one or less buffers per port in a hardware interface by using hardware flow control to prevent buffer overflow. In addition to reducing the memory buffer requirements, this invention can provide priority service classifications of Ethernet switch ports connected to a common flow control mechanism. The hardware interface can be a custom designed circuit, such as a FPGA or an ASIC, or can be formed of discrete components.

An embodiment of the present invention uses half-duplex, hardware Flow Control between an FPGA and a common Ethernet switch engine to reduce the amount of internal buffering required inside an FPGA. This maintains a high level of performance by taking advantage of the inherent buffering available inside a switch engine while reducing the external memory buffer requirements to the absolute minimum needed for packet processing. Port service priority can be implemented in simple logic to control the back-pressure mechanism to the packet source rather than adding more external buffering to store packets while controlling their transmission priority with logic at the buffer output.

Other particular advantages of the invention over what has been done before include, but are not limited to:

The use of Hardware Flow Control back-pressure to control a group of related ports rather than a single point to point link as it was originally intended allows the multiplexing of several Ethernet ports onto a single port of a dissimilar network type.

Using the half-duplex back-pressure mechanism allows implementation of a priority-based service scheme across a group of related Ethernet ports.

These and other advantages of the present invention will become apparent upon review of the following detailed description, the accompanying drawings, and the appended claims.

### BRIEF DESCRIPTION OF THE DRAWINGS

FIG. 1 is a simplified block representation of a prior art interface between network devices of different transfer rates.

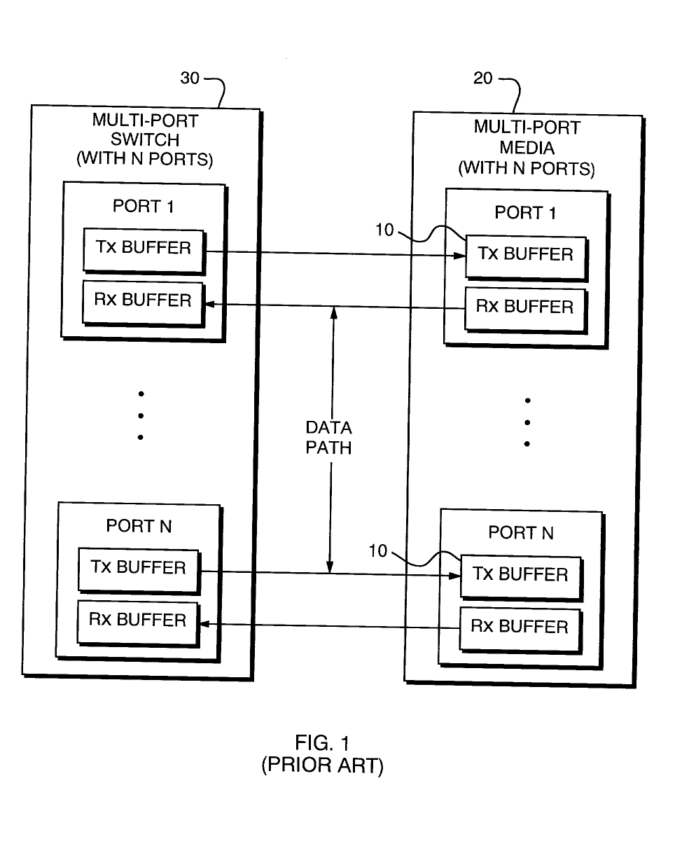

FIG. 2 is a simplified block representation of the interface system of the present invention.

FIG. 3 is a first simplified representation of the interface block of the present invention.

FIG. 4 is a second simplified representation of the interface block of the present invention.

FIG. 5 is a flow diagram illustrating the flow control method of the present invention.

FIG. 6 is a simplified representation of the priority servicing provided by the interface block of the present invention.

### DETAILED DESCRIPTION OF THE PREFERRED EMBODIMENT OF THE INVENTION

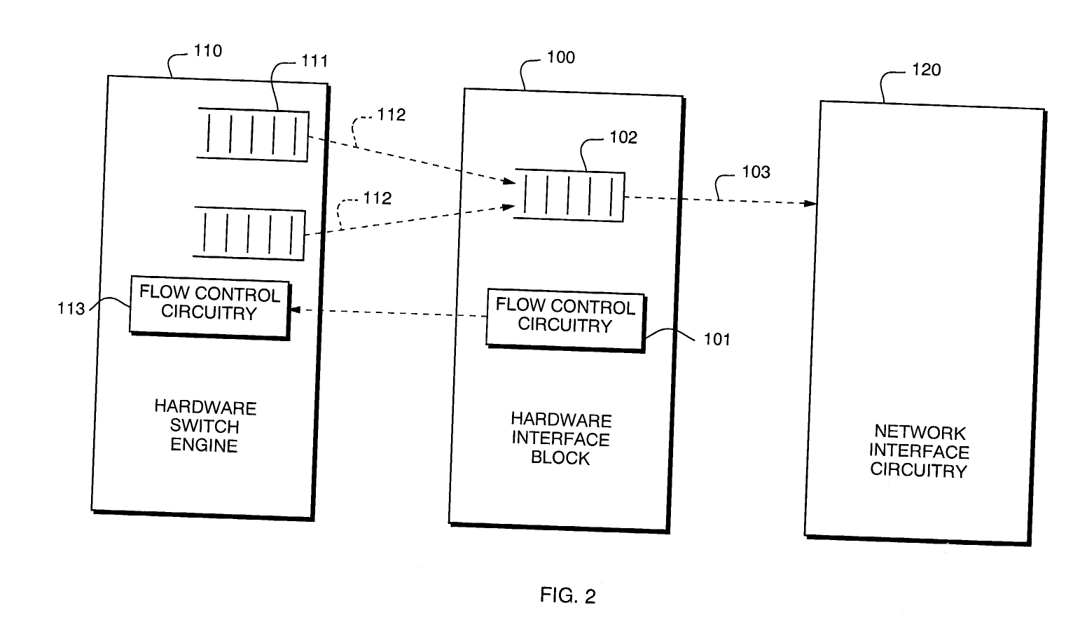

A flow control system 100 of the present invention is illustrated in simplified form in FIG. 2 in combination with a generic multi-port Ethernet switch engine 110 and network interface circuitry 120 that is not a multi-port device and/or does not transfer data at the same rate that the switch engine 110 does. The switch engine 110 is a common, multi-port Ethernet switch engine used to provide the basic switching functionality including packet storage buffers 111 at output transmit interface 112. An example of a representative device suitable for that purpose is the Matrix™ switch offered by Enterasys Networks, Inc. of Portsmouth, N.H. Those skilled in the art will recognize that the switch engine 110 may be any sort of multi-port switching device running any sort of packet switching convention, provided it includes storage buffers or interfaces with suitable storage buffers and transmit interfaces. The flow control system 100 includes flow control circuitry 101 coupled to flow control circuitry 113 of the switch engine 110. Together circuitry 101 and 113 regulate output from the buffers 111 via the transmit interfaces 112 to an interface block storage buffer 102 for output to the network interface circuitry 120 via intermediate transmit interface 103. In effect, the flow control system 100 is a hardware interface block 100 that operates as a translator from a first interface type, such as interfaces 112, to a dissimilar interface type, such as interface 103.

The switch engine 110 contains storage buffers 111 at each of its output ports represented as the terminals of the transmit interfaces 112. This is the primary storage for packets waiting to be sent to the next stage. If the next stage is not available, as indicated by the assertion of flow control back-pressure, then data packets are stored in these transmit buffers 111 until the next stage is ready to accept them.

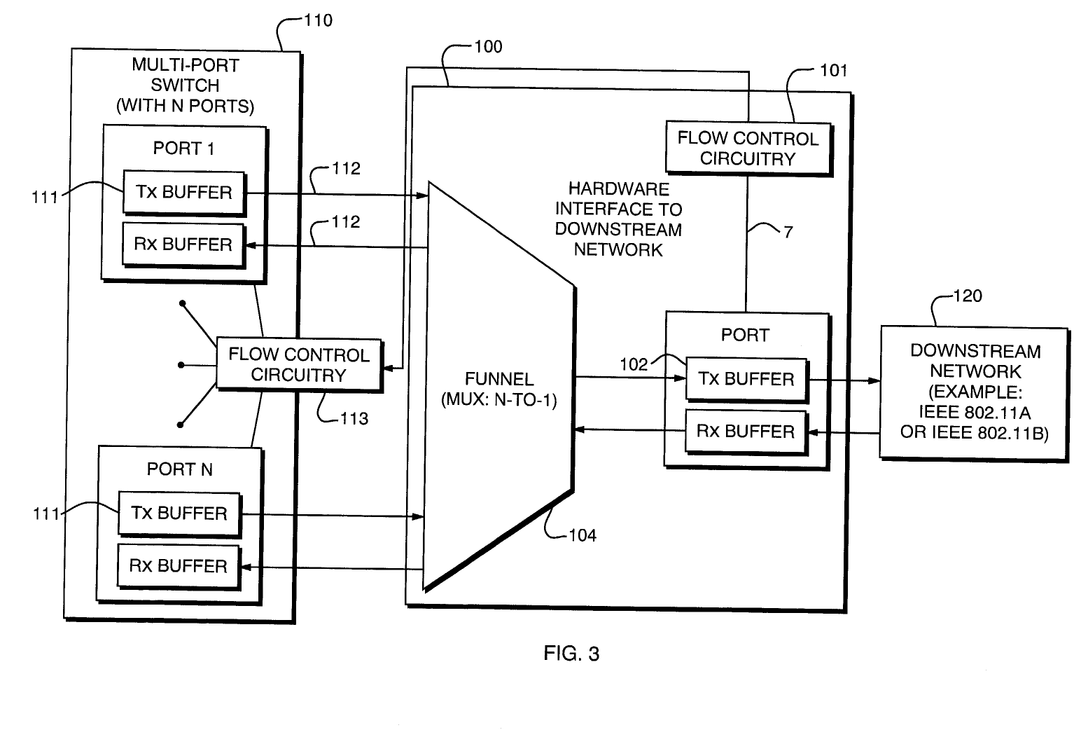

As illustrated in FIG. 3, the multiple ports of the interfaces 112 are effectively multiplexed together at the multiplexer interface 104 between the switch engine 110 and the hardware interface block 100 to another type of network represented as circuitry 120. The specific interfaces 112 can be any one of a number of different types such as Media Independent Interface (MII), Reduced Media Independent Interface (RMII), Serial Media Independent Interface (SMII), etc. The same can be said for interface 103, which may also be a standard PCMCIA interface. The circuitry of the switch engine 110 typically defines the specific configuration of the hardware interface block 100 and the hardware interface block 100 is then designed to match the predefined interface of the switch engine 110. The hardware interface block 100 provides any necessary port multiplexing, flow control and packet conversions between the dissimilar network types that could be running at different line speeds.

The input buffer 102 in the hardware interface block 100 is used to store a transmitted packet until the network interface circuitry 120 is ready for it. The buffer 102 is necessary as a speed matching mechanism when the switch engine 110 and the final or downstream network circuitry 120 are running at different speeds. It is also used as local data packet storage within the hardware interface block 100 while any necessary packet format conversions are being done. The link between the hardware interface block 100 and the final network interface circuitry 120 can be any appropriate interface such as PCMCIA, CardBus, USB, etc. Typically the network interface circuitry 120 has a predefined interface and the hardware interface block 100 will be designed to match the circuitry's interface.

The network interface circuitry 120 is the final stage in the packet's transmit path. This interface circuitry 120 will typically have the appropriate circuitry for Data Link and Physical Layer transmission onto the attached network medium. For example, this circuitry 120 could be a PCMCIA card that supports an IEEE 802.11b wireless network. It is to be understood that each of the primary components described herein may be separate devices or all integrated together. For example, the switch 110 and the interface block 100 may be formed as part of a single structure and essentially act as a single structure.

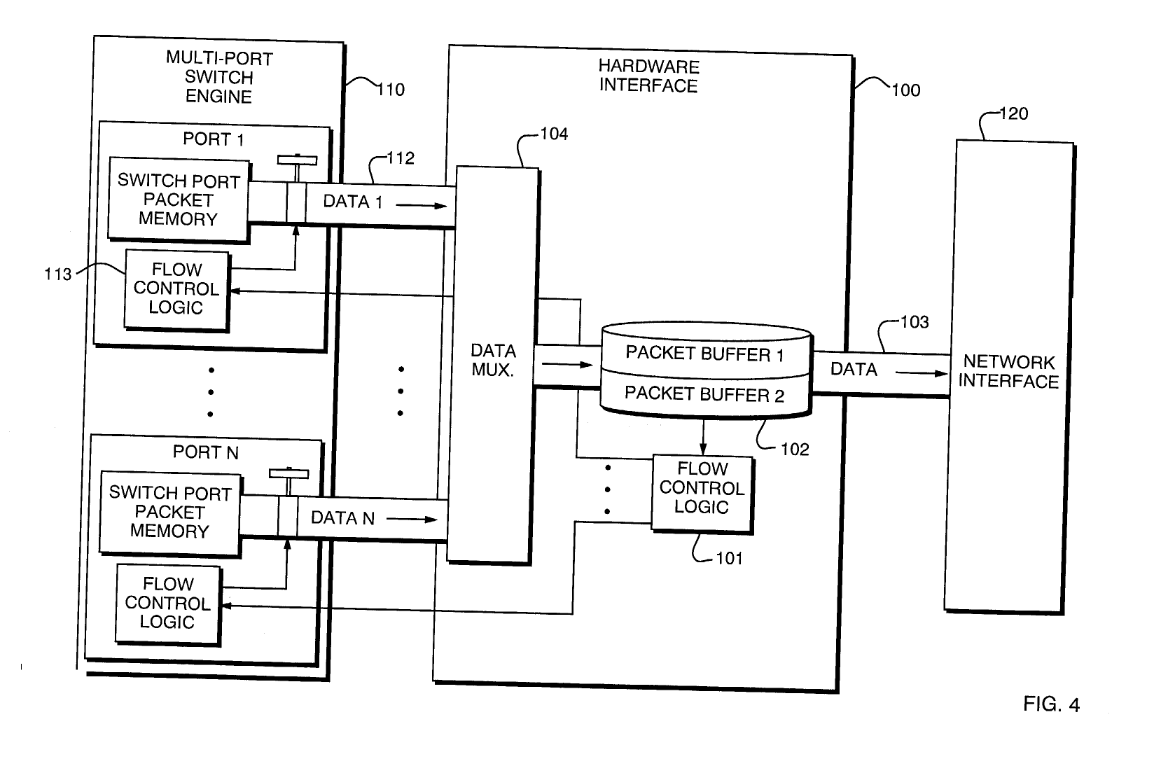

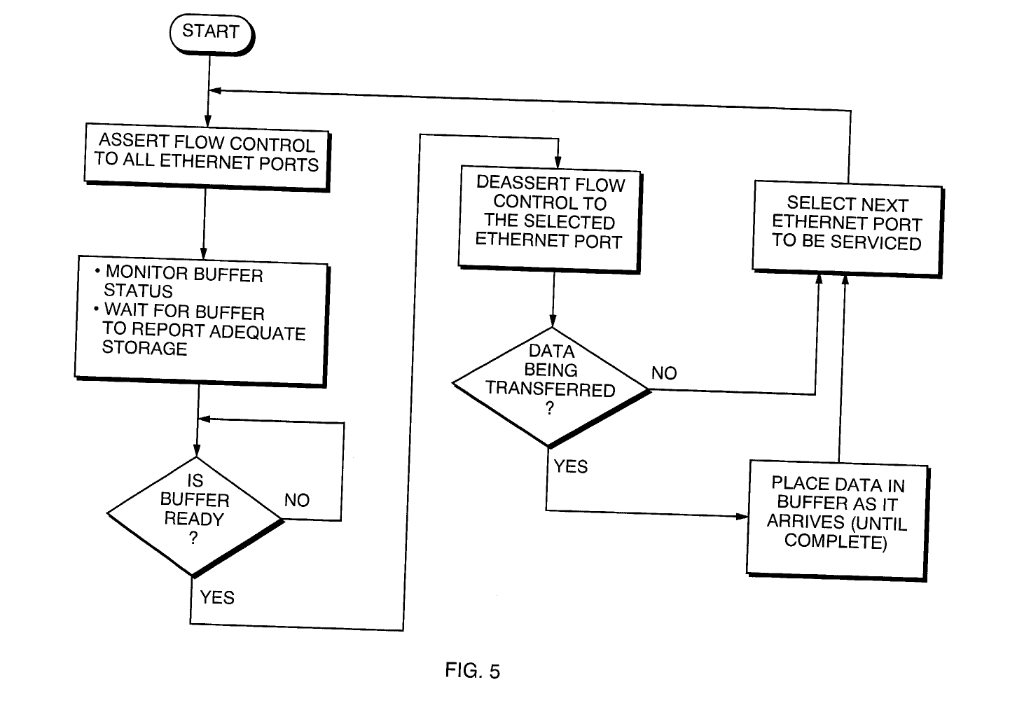

As illustrated in FIG. 4, the flow control circuitry 101 in the hardware interface block 100 controls the flow of data packets from the switch 110 to the network interface 120. Flow control, preferably in the form of half-duplex network back-pressure asserted to corresponding flow control circuitry 113 of the switch 110, is used to prevent the switch 110 from sending any data packets to the hardware interface block 100 until there are services available to process the data packet. For example and with reference to the flow diagram of FIG. 5, assume there is a single data buffer 102 in the hardware interface block 100 and there are six example switch transmit interfaces 112 connected to that hardware interface block 100. The hardware interface block 100 can only process a single packet at a time from a single one of the interfaces 112. It will force back-pressure to the other five switch interfaces 112 to prevent them from transmitting any data packets to the hardware interface block 100. Once the hardware interface block 100 has processed the first packet and its buffer 102 becomes available, it will release the back-pressure on one of the other interfaces 112 to allow a second data packet into the hardware interface block 100 for processing. This process is repeated on all of the interfaces 112 to give each interface (port) the chance to transmit packets if it is ready to do so. Establishing back-pressure on all ports as the default is preferable to employing inter-packet gap of the type associated with Ethernet collision detection and back-off reduces the likelihood of buffer overrun occurring in the hardware interface block 100, thereby avoiding data loss in the smaller interface block buffer. Instead, packets are stored in the much larger buffers of the switch engine 110, where data loss is substantially less likely.

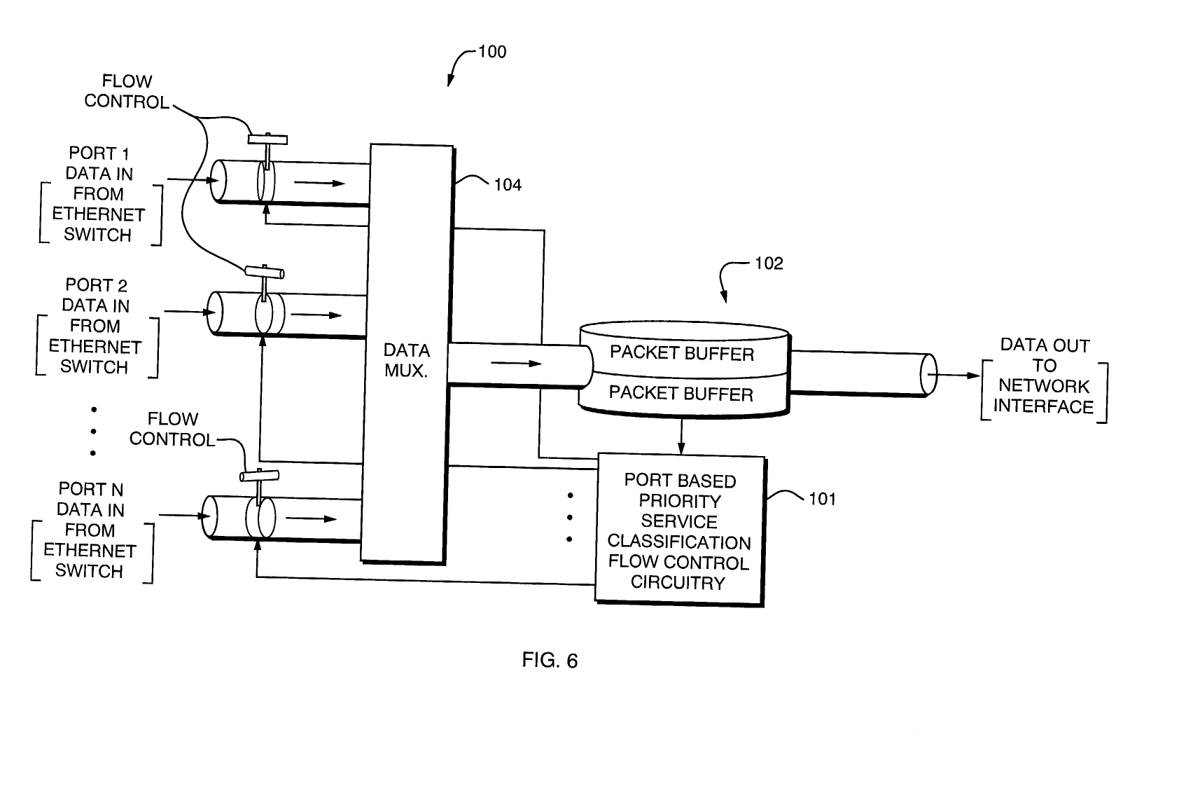

With reference to FIG. 6, transmit priority can be established by the port polling sequence and service policy. The flow control circuitry 101 can poll the transmit interfaces 112 in any desired sequence to give priority to a given port or ports. It can also establish priority service by the number of data packets that are accepted from a given port before a different port is given a chance to transmit. For example, a high priority port may be allowed to transmit several packets back to back while a lower priority port may only be allowed to transmit one or two packets before it is back-pressured.

With reference to FIG. 4, the medium by which the back-pressure flow control is applied is the standard medium connection between the switch 110 and the hardware interface block 100. It is typically an RMII or MII but it can be any connection capable of half-duplex operation between the blocks. It is important that the connection be half-duplex because this type of connection allows immediate control of the transmit mechanism in the switch 110, which is the packet source. The immediate control allows the flow control circuitry in the hardware interface block 100 to control packet flow on a packet by packet basis. The flow control may be of any suitable type however, a standard Ethernet full duplex flow control mechanism that uses Pause frames in the receive path to stop transmission of data packets is considered less than ideal. That is because such a mechanism cannot insure that transmit packets will stop being sent exactly when the Pause frame is received and therefore multiple packets may be transmitted before the flow control stops the transmission. In the present invention, the flow control circuitry 113 in the switch 110 is responsible for sensing that back-pressure has been applied to the port by the flow control logic 101 and then stopping any further transmissions until the back-pressure has been released.

The present invention provides useful features. They include, but are not limited to a mechanism to simplify the interface logic between dissimilar networks. This is achieved through the application of the half-duplex flow control to reduce memory buffer requirements to less than one buffer per switch port. Further, the half-duplex flow control permits implementation of priority servicing scheme across several ports. In addition, multiplexing of a plurality of switch ports onto a single network port is enabled with minimum buffering while maintaining high performance.

Alternate constructions, configurations, components, or methods of operation of the invention include, but are not limited to:

The switch engine 110 could be a custom ASIC, programmable part or a proprietary switching engine.

The hardware interface block 100 may be part of the switch engine 110 or the interface block 120, or part of each.

The switch engine 110 may be any data source that allows a back-pressure mechanism to control the transmit packet flow.

This scheme does not need to be used only between dissimilar network types. It can be used between any same or different networks where one network cannot accept packets at the same rate as they are being offered from the other network.

While the present invention has been described with specific reference to a particular embodiment, it is not limited thereto. Instead, it is intended that all modifications and equivalents fall within the scope of the following claims.

What is claimed is:

1. A system to enable electronic signal exchange between a first network and a second network, the system comprising:
a. a switch engine connected to receive signals of a first one of the two networks and having a plurality of output communication ports for the transfer of the signals between the first network and the second network and at least one transmit signal storage buffer for each of the output communication ports;
b. a hardware interface block having: i) a plurality of input communication ports connected to the switch engine for receiving signals from the output communication ports of the switch engine; ii) a multiplexer connected to the plurality of input communication ports for multiplexing the received signals; iii) flow control circuitry connected to the switch engine to regulate packet transfer from the switch engine to the input communication ports; and iv) an interface transmit packet buffer component connected to the multiplexer, wherein the transmit packet buffer component includes one or more packet buffers fewer in number than the number of the transmit signal storage buffers of the switch engine; and
c. network interface circuitry connected to the hardware interface block for transferring signals from the transmit packet buffer component to the second of the two networks.

2. The system as claimed in claim 1 wherein the flow control circuitry of the hardware interface block is connected to corresponding flow control circuitry of the switch engine and wherein the flow control circuitry of the hardware interface block is configured to assert back-pressure on the flow control circuitry of the switch engine to establish control on the output of signals from the switch engine to the hardware interface block.

3. The system as claimed in claim 2 wherein the flow control circuitry of the hardware interface block is further configured to define priority queuing of the output from the output ports of the switch engine.

4. The system as claimed in claim 2 wherein the flow control circuitry of the switch engine is configured to stop transmissions to the hardware interface block for a specific one of the output ports having back pressure thereon until such back pressure is removed by the flow control circuitry of the hardware interface block.

5. The system as claimed in claim 1 wherein the switch engine and the hardware interface block are embodied in a single Application Specific Integrated Circuit.

6. A method to regulate with an interface system the transfer of data signals from a first network to a second network, wherein the interface system includes a switch engine having a plurality of output ports and a corresponding number of transmit packet storage buffers, and a hardware interface block having an interface transmit packet buffer connected to the switch engine, the method comprising the steps of:
a. asserting flow control to all output ports of the switch engine;
b. monitoring the status of the interface transmit packet buffer to accept and store data signals;
c. de-asserting flow control to a selected one or more of the output ports of the switch engine when the interface transmit packet buffer is available to accept; and
d. transmitting data signals from the selected one or more output ports to the interface transmit packet buffer in preparation for transmission to the second network.

7. The method as claimed in claim 6 further comprising the step of matching in the hardware interface block the rate of data transmission corresponding to the data transmission rate of the second network.

8. The method as claimed in claim 6 further comprising the step of converting in the hardware interface block the format of the packets received from the first network into a format compatible with the format of the second network.

9. The method as claimed in claim 6 further comprising the step of transmitting the data signals to the second network via network interface circuitry.

10. The method as claimed in claim 6 wherein the switch engine is an Ethernet switch engine and the step of asserting flow control includes the application of half-duplex back pressure on the output ports of the switch engine.

11. The method as claimed in claim 6 wherein the steps of asserting and de-asserting are performed by flow control circuitry of the switch engine and the hardware interface block.

12. The method as claimed in claim 11 further comprising the step of asserting priority queuing on the output ports of the switch engine.
